(19) United States
(12) Patent Application Publication
(10) Pub. No.: US 2012/0234325 A1
(43) Pub. Date: Sep. 20, 2012

(54) Air Control Valve

(76) Inventors: Wai To LI, Hong Kong (CN); Yue Fu Zhu, Shenzhen (CN)

(21) Appl. No.: 13/422,717

(22) Filed: Mar. 16, 2012

(30) Foreign Application Priority Data
Mar. 17, 2011 (CN) 201110065057.6

(51) Int. Cl. A62B 9/02

(52) U.S. Cl. 128/205.24

(57) ABSTRACT

An air control valve includes a body which includes a passage with an inlet and an outlet, and a chamber located between and communicated with the inlet and the outlet. The air control valve further includes a valve element rotatably disposed in the chamber, and a motor connected to the valve element for driving the valve element to rotate between a first position where the outlet communicates with the inlet and a second position where the valve element disconnects the outlet from the inlet.

### CROSS REFERENCE TO RELATED APPLICATIONS

This non-provisional patent application claims priority under 35 U.S.C. §119(a) from Patent Application No. 201110065057.6 filed in The People's Republic of China on Mar. 17, 2011.

### FIELD OF THE INVENTION

This invention relates to an electrically operated air control valve and in particular, to an air control valve for a medical respiratory device such as a nebulizer.

### BACKGROUND OF THE INVENTION

Medical nebulizers are widely used for treatment of cystic fibrosis, asthma and other respiratory diseases. A medical nebulizer usually comprises two passages one for delivering droplets of a medical liquid and the other for delivering an air stream which is generated by a recipient's inhalation through a mouthpiece. The two passages are joined together at a joint near the mouthpiece. Each passage is provided with a control valve for controlling the delivery of droplets of a medical liquid and air.

The present invention is to provide a new air control valve for controlling the delivery of air/gas in a medical respiratory device such as a nebulizer.

### SUMMARY OF THE INVENTION

Accordingly, in one aspect thereof, the present invention provides an air control valve for a medical respiratory device, comprising: a body having a chamber with an inlet and an outlet; a valve element rotatably disposed within the chamber, the valve element defining a channel; and a motor comprising a shaft which is connected to the valve element for rotating the valve element between a first position where the channel of the valve element connects the outlet to the inlet of the body and a second position where the valve element disconnects the outlet from the inlet.

Preferably, the shaft is loosely connected to the valve element to allow for slight differences between the axis of the shaft of the motor and the rotational axis of the valve element.

Preferably, the valve element defines a non-circular mounting hole, and a coupling is fixed on the shaft of the motor and loosely fitted in the mounting hole, the coupling having a shape corresponding to that of the mounting hole.

Preferably, wherein the mounting hole is a hexagonal hole and the coupling is a hexagonal nut fixed to the shaft by a threaded connection, the hexagonal nut being slightly smaller than the hexagonal hole.

Preferably, the coupling comprises a connecting portion which engages the mounting hole and a base from which the connecting portion extends, and the valve element defines a recess for receiving the base of the coupling, the mounting hole extending from the recess in a direction away from the motor.

Alternatively, the valve element defines a through hole extending along a rotational axis thereof, and the shaft of the motor extends through the through hole and one end of the shaft is supported by a bearing which is fixedly mounted at the closed end of the chamber of the body.

Preferably, a limiting structure is formed between the body and the valve element for limiting rotation of the valve element between the first and second positions.

Alternatively, the limiting structure comprises an arc shaped recess formed in the body and a protrusion formed on the valve element, the protrusion being movable in the recess when the valve element is rotated between the first and second positions.

Alternatively, the limiting structure comprises an arc shaped block formed on an inner circumferential surface of the chamber and an arc shaped protrusion formed on an outer circumferential surface of the valve element, opposite circumferential ends of the block respectively contacting with opposite ends of the protrusion when the valve element is in the first and second positions.

Alternatively, the chamber comprises an open end adjacent to the motor and a closed end away from the motor, a washer being sandwiched between the body and the motor for sealing the open end of the chamber.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is an assembled view of an air control valve in accordance with a first embodiment of the present invention;

FIG. 2 is an exploded view of the valve of FIG. 1;

FIG. 3 illustrates a valve element of the air control valve of FIG. 1;

FIG. 4 illustrates a motor of the air control valve of FIG. 1;

FIG. 5 is a part sectional view of the air control valve of FIG. 1;

FIG. 6 is an exploded view of an air control valve in accordance with a second embodiment of the present invention;

FIG. 7 illustrates a valve element of the air control valve of FIG. 6;

FIG. 8 illustrates the coupling of the air control valve of FIG. 6;

FIG. 9 is an exploded view of an air control valve in accordance with a third embodiment of the present invention;

FIG. 10 is a part sectional view of the air control valve of FIG. 9;

FIGS. 11 & 12 show a limiting structure of an air control valve in accordance with a fourth embodiment of the present invention;

FIGS. 13 & 14 show a limiting structure of an air control valve in accordance with a fifth embodiment of the present invention; and

FIGS. 15 & 16 show a limiting structure of an air control valve in accordance with a sixth embodiment of the present invention.

### DETAILED DESCRIPTION OF THE PREFERRED EMBODIMENTS

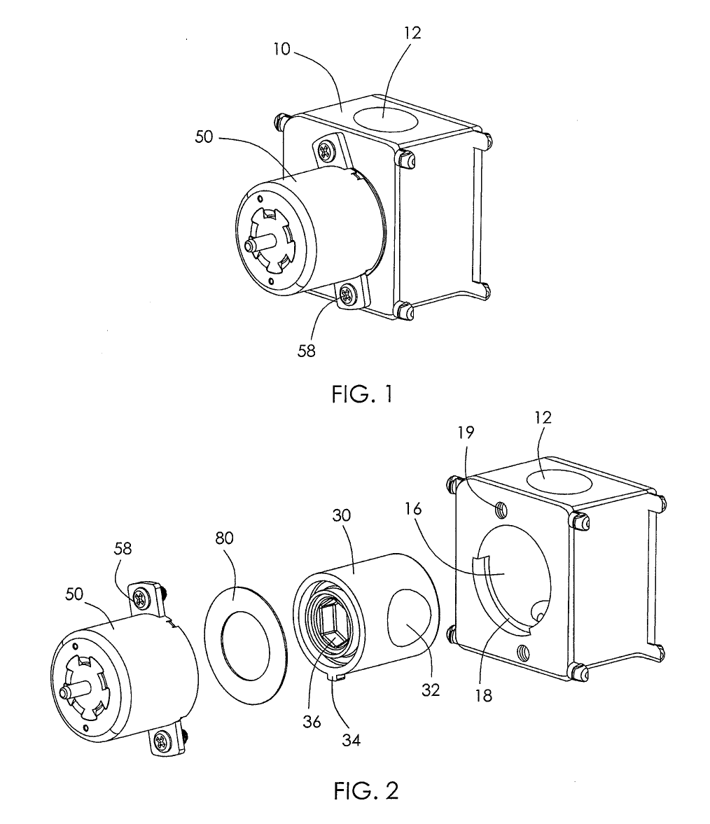

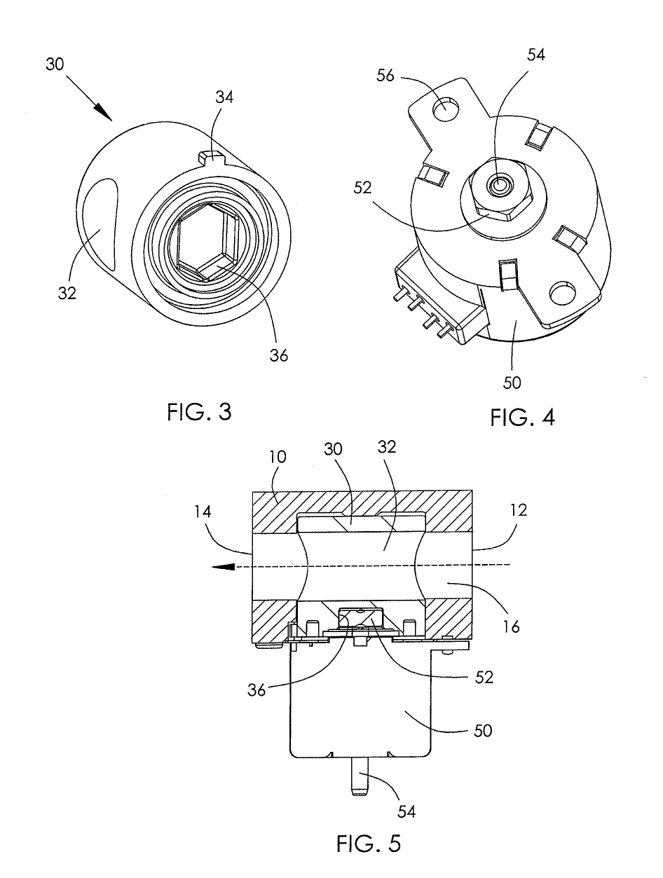

The first preferred embodiment of the air control valve of the present invention will be described with reference to FIGS. 1 to 5. The air control valve according to the present invention may be used for medical nebulizers and other medical apparatus which need a control valve to control the delivery of air/gas.

As shown in FIGS. 1-5, the air control valve comprises a body 10 which has a chamber 16. The chamber 16 has an inlet 12, an outlet 14, a closed end and an open end opposite the closed end.

The air control valve further comprises a valve element 30 pivotably disposed within the chamber 16, a motor 50 connected to the valve element 30 to rotate the valve element 30 between a first position where the inlet 12 communicates with the outlet 14 and a second position where the outlet 14 is isolated from the inlet 12. The valve element 30 has a channel 32 which connects the inlet 12 and the outlet 14 when the valve element 30 is located at the first position.

A washer 80 is sandwiched between the body 10 and the motor 50 to seal the open end of the chamber 16. The valve element 30 lightly contacts the washer 80 and is rotatable relative to the washer 80. Optionally, seals may be provided between the inlet and/or outlet and the valve element to reduce leakage around the valve element.

A limiting structure, for limiting rotation of the valve element 30 between the first position and the second position, is formed between the body 10 and the valve element 30. Preferably, the limiting structure is configured such that the valve element 30 is rotatable through an angle which is greater than 90 degrees. In this embodiment, the motor 50 is a stepper motor and the valve element 30 is rotatable through 108 degrees between the first position and the second position. Specifically, the limiting structure comprises an arc shaped recess 18 formed in the body 10 in the edge of the open end of the chamber 16 and a protrusion 34 formed on the valve element 30. The protrusion 34 moves along the recess 18 when the valve element 30 is rotated between the first and second positions with the protrusion bearing against ends of the recess when the valve element is in the first or second position.

A coupling, in the form of a hexagonal nut 52, is fixed to the end of the shaft 54 of the motor 50 by a threaded connection. One end of the valve element 30 facing the motor defines a hexagonal mounting hole 36 which has a shape corresponding to that of the nut 52. The hexagonal nut 52 is slightly smaller than the hexagonal hole 36. When assembled, the nut 52 is loosely fitted in the mounting hole 36 such that the valve element 30 is able to slightly move relative to the shaft 54 of the motor 50 and is rotated by the shaft 54 of the motor 50. Thus, a slight deviation between the axis of the shaft 54 of the motor 50 and the axis of the valve element 30 can be compensated by the gap between the nut 52 and the mounting hole 36 of the valve element 30, to thereby avoid the valve element 30 being jammed in the chamber 16 due to a slight misalignment of the motor.

The motor 50 has a pair of mounting lugs each having a through hole 56. The body 10 defines a pair of attachment holes 19 at opposite sides of the open end of the chamber 16. The motor 50 is attached to the body 10 by a pair of fasteners 58 which pass through the through holes 56 of the motor 50 and engage with the attachment holes 19 of the body 10. In this embodiment, the fasteners 58 are screws.

As shown in FIG. 5, in use, the valve element 30 is rotated by the motor 50 to the first position where the channel 32 of the valve element 30 connects the inlet 12 to the outlet 14. Thus air can flow through the chamber 16 from the inlet 12 to the outlet 14 via the channel 32. To close the valve, the motor rotates the valve element to the second position where the channel 32 is not aligned with the inlet or outlet, thus disconnecting the outlet from the inlet.

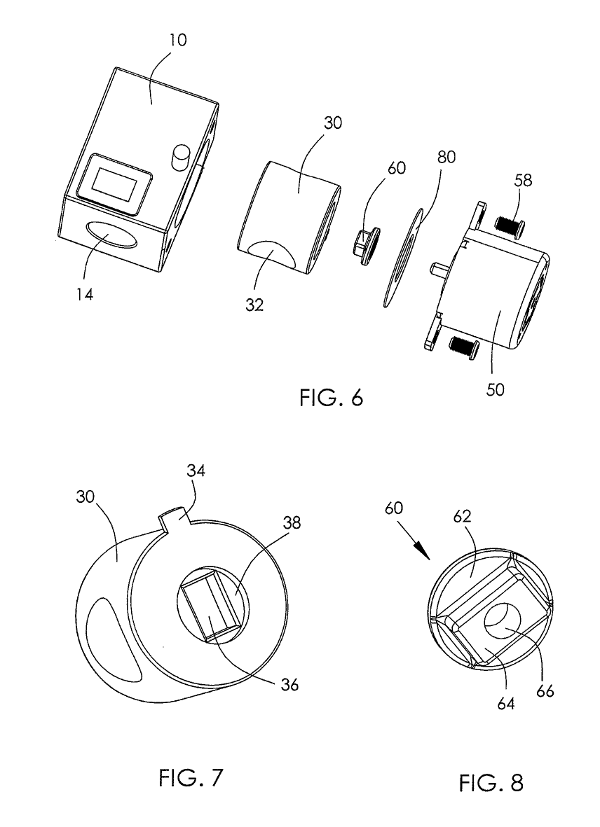

FIGS. 6-9 show an air control valve in accordance with a second embodiment of the present invention. This air control valve is similar to the air control valve of the first embodiment except that the nut is replaced by a coupling 60.

The coupling 60 comprises a base 62, a connecting portion 64 protruding from the base 62. A fixing hole 66 is defined at the center of coupling 60 such that the shaft 54 of the motor 50 may be fixed in the fixing hole 66 to thereby fix the coupling 60 to the shaft 54. The valve element 30 defines a recess 38 at one end thereof adjacent to the motor 50. The shape of the recess 38 corresponds to that of the base 62 of the coupling 60. The valve element 30 further defines a mounting hole 36 which has a shape corresponding to that of the connecting portion 64 of the coupling 60. The hole 36 starts from the recess 38 and extends axially in a direction away from the motor 50. When assembled, the base 62 of the coupling 60 is received in the recess 38 of the valve element 30 and the connecting portion 64 is received in the mounting hole 36, such that the valve element 30 is rotatable with the coupling 60 which is driven by the shaft 54 of the motor 50. The shape of the connecting portion 64 of the coupling 60 is non-circular, such as triangle, square, rectangular, hexagonal and so on. The shape of mounting hole 36 corresponds to that of the connecting portion 64 but the size of the connecting portion 64 is slightly smaller than that of the mounting hole 36 such that a small gap is formed between the connecting portion 64 and the mounting hole 36.

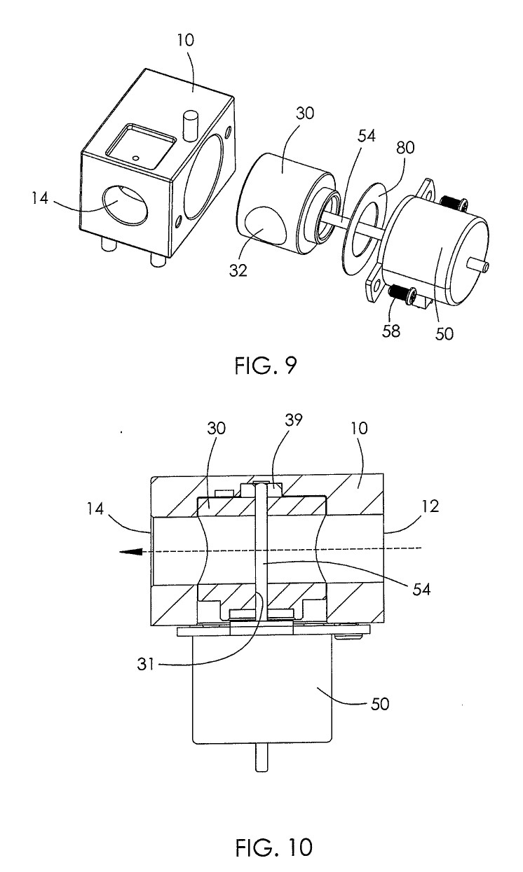

FIGS. 9-10 show an air control valve in accordance with a third embodiment of the present invention. This air control valve is similar to the air control valve of the first embodiment except that the valve element is fixed directly to the shaft. The valve element 30 has a through hole 31 extending along the rotational axis thereof. The shaft 54 of the motor 50 extends through the through hole 31 and the distal end of the shaft 54 is supported by a bearing 39 fixedly mounted in the closed end of the chamber 16. The valve element 30 is a press fit on the shaft 54 and therefore rotatable with the shaft 54.

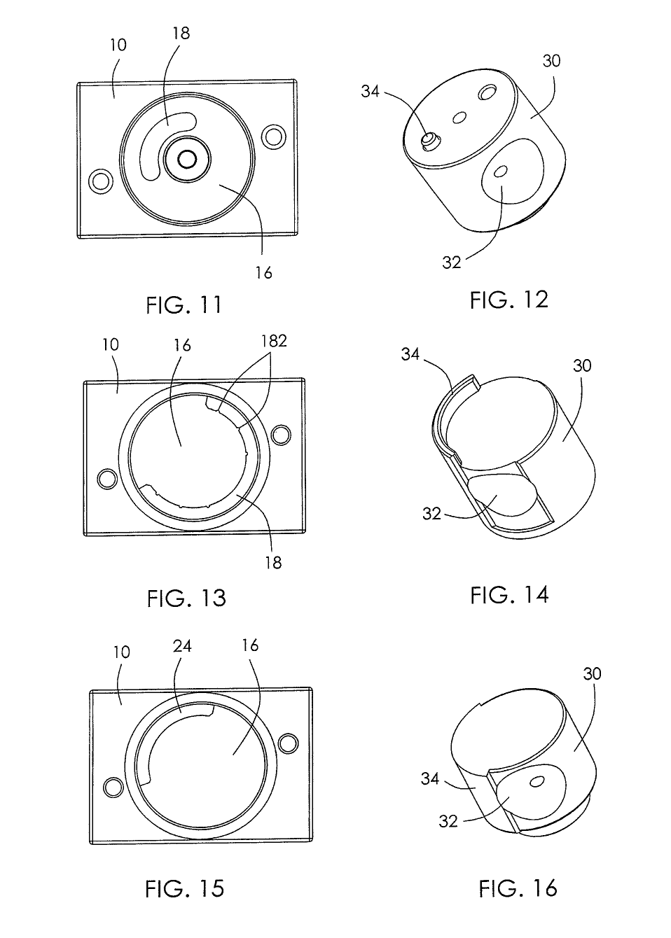

FIGS. 11-12 show a limiting structure of an air control valve in accordance with a fourth embodiment of the present invention. The limiting structure comprises an arc shaped recess 18 formed in the closed end of the chamber 16. The valve element 30 is provided with a protrusion 34 which is slidably received in the arc shaped recess 18 to limit the angle of rotation of the valve element.

FIGS. 13-14 show a limiting structure of an air control valve in accordance with a fifth embodiment of the present invention. The limiting structure comprises an arc shaped recess 18 defined in the closed end of the chamber 16. The valve element 30 has an arc shaped protrusion 34 that is slidably received in the arc shaped recess 18. A plurality of discrete ribs 182 are formed along a side the arc shaped recess 18 for slidably contacting with the protrusion 34 to thereby decrease friction between the body 10 and the valve element 30.

FIGS. 15-16 show a limiting structure of an air control valve in accordance with a sixth embodiment of the present invention. The limiting structure comprises an arc shaped block 24 formed on the inner circumferential surface of the chamber 16. The valve element 30 is provided with an arc shaped protrusion 34 on the outer circumferential surface thereof. The inner diameter of the arc shaped block 24 is smaller than the outer diameter of the arc shaped protrusion 34. When the valve element 30 is in the first position one circumferential end of the protrusion 34 contacts with one circumferential end of the block 24, and when the valve element 30 is in the second position the other circumferential end of the protrusion 34 contacts with the other circumferential end of the block 24.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. An air control valve for a medical respiratory device, comprising:
a body having a chamber with an inlet and an outlet;
a valve element rotatably disposed within the chamber, the valve element defining a channel; and
a motor comprising a shaft which is connected to the valve element for rotating the valve element between a first position where the channel of the valve element connects the outlet to the inlet of the body and a second position where the valve element disconnects the outlet from the inlet.

2. The air control valve of claim 1, wherein the shaft is loosely connected to the valve element to allow for slight differences between the axis of the shaft of the motor and the rotational axis of the valve element.

3. The air control valve of claim 2, wherein the valve element defines a non-circular mounting hole, and a coupling is fixed on the shaft of the motor and loosely fitted in the mounting hole, the coupling having a shape corresponding to that of the mounting hole.

4. The air control valve of claim 3, wherein the mounting hole is a hexagonal hole and the coupling is a hexagonal nut fixed to the shaft by a threaded connection, the hexagonal nut being slightly smaller than the hexagonal hole.

5. The air control valve of claim 3, wherein the coupling comprises a connecting portion which engages the mounting hole and a base from which the connecting portion extends, and the valve element defines a recess for receiving the base of the coupling, the mounting hole extending from the recess in a direction away from the motor.

6. The air control valve of claim 1, wherein the valve element defines a through hole extending along a rotational axis thereof, and the shaft of the motor extends through the through hole and one end of the shaft is supported by a bearing which is fixedly mounted at the closed end of the chamber of the body.

7. The air control valve of claim 1, wherein a limiting structure is formed between the body and the valve element for limiting rotation of the valve element between the first and second positions.

8. The air control valve of claim 7, wherein the limiting structure comprises an arc shaped recess formed in the body and a protrusion formed on the valve element, the protrusion being movable in the recess when the valve element is rotated between the first and second positions.

9. The air control valve of claim 7, wherein the limiting structure comprises an arc block formed on an inner circumferential surface of the chamber and an arc protrusion formed on an outer circumferential surface of the valve element, opposite circumferential ends of the block respectively contacting with opposite ends of the protrusion when the valve element is in the first and second positions.

10. The air control valve of claim 1, wherein the chamber comprises an open end adjacent to the motor and a closed end remote from the motor, a washer being sandwiched between the body and the motor for sealing the open end of the chamber.

11. The air control valve of claim 3, wherein a limiting structure is formed between the body and the valve element for limiting rotation of the valve element between the first and second positions.

12. The air control valve of claim 6, wherein a limiting structure is formed between the body and the valve element for limiting rotation of the valve element between the first and second positions.
